(19) United States
(12) Patent Application Publication
(10) Pub. No.: US 2019/0073691 A1
(43) Pub. Date: Mar. 7, 2019

(54) OPTIMIZATION OF CONTENT PLACEMENT ON CHANNELS

(71) Applicant: Facebook, Inc., Menlo Park, CA (US)

(72) Inventors: Ori Hanegby, Saratoga, CA (US); Max K. Comer, San Francisco, CA (US); Chinmay Deepak Karande, Mountain View, CA (US); Ruoyu Zhang, Morgan Hill, CA (US); Joshua Elliot Geller, Mountain View, CA (US); Jie Xu, Foster City, CA (US); Nuwan Senaratna, Sunnyvale, CA (US)

(21) Appl. No.: 15/694,730

(22) Filed: Sep. 1, 2017

(51) Int. Cl. G06Q 30/02

(52) U.S. Cl. CPC G06Q 30/0244; G06Q 50/01; G06Q 30/0269; G06Q 30/0277

(57) ABSTRACT

A method for enabling a content sponsor to design a cost-effective content campaign. The content sponsor initiates a content campaign. The content sponsor is presented with a set of proposed channels on which to display the content and either accepts the proposed channels or selects an alternative set of channels. If an alternative set of channels is chosen, the content sponsor is presented with an alert comprising data predicting the result of presenting the content on the alternative set of channels. If the content sponsor does not heed the alert, the content sponsor is presented with an option to implement a split test, which involves implementing multiple content campaigns using different sets of channels. Finally, a result report is presented to the content sponsor. In some embodiments, the result report comprises a counterfactual report comparing the results of two or more campaigns implemented using different sets of channels.

### BACKGROUND

This disclosure relates generally to selecting channels for placement of sponsored content, and more specifically relates to evaluating electronic placement channels for content placement effectiveness. Content sponsors have the opportunity to display sponsored content to target users on certain channels. A channel comprises a set of sponsored content slots that may be located at different locations and accessed by different target users. Depending upon the set of channels chosen to display content, performance of sponsored content may vary widely. Performance of sponsored content may vary based upon the set of channels on which content is displayed. Often, a content sponsor's objective is to maximize performance of the sponsored content achieved through the display of sponsored content. However, a large quantity of factors influencing performance of sponsored content on each channel may make it difficult for content sponsors to determine which channels to target in order to maximize cost-effectiveness of a content campaign, and sponsors may lack tools to effectively evaluate different channels.

### SUMMARY

A method for enabling a content sponsor to design and implement a cost-effective content campaign. First, the content sponsor inputs sponsored content and one or more display criteria. In some embodiments, sponsored content may include text, image, audio, video, or any other suitable data that can be presented to a user. In various embodiments, the sponsored content also specifies a page of content. Display criteria may include specifications of a campaign budget, a bid price, user targeting criteria, and any additional parameters used to facilitate presentation of the content to a user.

Next, the content sponsor is presented with proposed channels for display of the content. A channel represents a set of sponsored content slots for which the content may be placed and which the content may compete with other content for placement to that channel. Sponsored content slots are locations at which sponsored content may be displayed. Sponsored content slots that are members of a channel may or may not be of the same type or origin. For example, in one embodiment, a channel may comprise sponsored content slots from a single publisher such as a website. In another embodiment, a channel may comprise sponsored content slots from multiple, diverse publishers and client devices. Thus, one channel may include sponsored content slots at a specific publisher, such as a social networking system, while another channel may include sponsored content slots in various mobile applications, and another may include sponsored content slots in a set of webpages. Additionally, each sponsored content slot may serve content to a different user or a different user demographic. Furthermore, each channel may also have a different set of rules for selecting content to be displayed at a given sponsored content slot. For example, a channel may limit the frequency at which a user is selected to be presented with sponsored content for a given content campaign. Thus each channel may thus represent different types or ways of addressing content to users.

Different bids and expected values for different channels allows the content sponsor to implement a shared budget campaign in which campaign funds are split, possibly unequally, between different channels. The channels proposed to the content sponsor are selected such that cost-effectiveness of the content campaign is maximized. Cost-effectiveness of a content campaign can be predicted using campaign objectives. In one embodiment, cost-effectiveness of a content campaign is predicted using the campaign objective specified by the content sponsor. In an alternative embodiment, if a campaign objective is not specified by the content sponsor, cost-effectiveness of a content campaign is predicted using a default campaign objective. Data used to predict the cost-effectiveness of targeting certain channels is sourced from a database that contains results from previously conducted content campaigns. Results from completed campaigns that were similar to the current campaign are used to predict the result of the current campaign.

The content sponsor makes a decision to either use the proposed channels in the content campaign, or to select an alternative set of desired channels for display of the sponsored content. If the content sponsor opts to use the proposed channels, the content campaign is implemented. On the other hand, if the content sponsor selects an alternative set of desired channels, an alert is presented to the content sponsor to highlight and explain expected inefficiency of the alternate channels. In some embodiments, the alert comprises data predicting the result of displaying the sponsored content on the alternative set of channels. In further embodiments, the alert comprises a report predicting reduced effectiveness as a result of altering the proposed channels targeted by the campaign. In an alternative embodiment, the alert may predict a discrepancy between objective fulfillment as a result of altering the channels targeted by the campaign. In a further embodiment, the alert may display a prediction of any alternative descriptor of cost-effectiveness. In some embodiments, the alert comprises a counterfactual report comparing results predicted for two or more different content campaign scenarios.

If the content sponsor opts to use the proposed channels as a result of viewing the alert, the content campaign is implemented. When the content sponsor continues with the selection of the alternative set of channels, the content sponsor is presented with an option to implement a split test. A split test allocates portions of the campaign budget to two or more content campaigns. For example, a split test may allocate one portion of the campaign budget to a first content campaign that uses the proposed set of channels and another portion of the campaign budget to a second content campaign that uses the alternative set of desired channels. In alternative embodiments, any number of content campaigns may be implemented using a split test. The purpose of the split test is to demonstrate, with real data, the predicted benefit of running the content campaign using the proposed set of channels as opposed to the alternative set of desired channels.

If the content sponsor opts to perform the split test, the split test is implemented. If the content sponsor opts out of the split test, the content campaign is implemented using the alternative set of desired channels. Following the implementation of the one or more content campaigns, the content sponsor is presented with one or more result reports. In some embodiments in which the split test was performed, the result report depicts the results of the split test. In some embodiments in which the split test was not implemented, the result report may compare the results of implementing the campaign targeting the alternative set of channels, to predicted results of implementing the campaign targeting the proposed set of channels. In embodiments in which the content sponsor chose to target only the proposed set of channels, the result report may simply depict the results received.

In some embodiments, the results depicted may be the amount of money earned by one or more content campaigns. In an alternative embodiment, the results depicted may be the quantity of objectives fulfilled by the one or more content campaigns. In a further embodiment, results depicted may comprise any alternative descriptor of cost-effectiveness of the campaigns. In embodiments in which results of one or more campaigns are compared, the result report may comprise a counterfactual report. A counterfactual report is a visual and easily-comprehensible comparison of results that may be used to allay any misconceptions regarding the cost-effectiveness of targeting one set of channels as opposed to another set of channels during a content campaign.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 illustrates selection of sponsored content for display, in accordance with one embodiment.

FIG. 4 is a flow chart of a method for optimizing placement of sponsored content, in accordance with an embodiment.

FIG. 5 is a diagram illustrating implementation of a content campaign, in accordance with one embodiment.

FIG. 6 illustrates cost effectiveness of content placement on two different channels, in accordance with one embodiment.

FIG. 7 illustrates a counterfactual report comparing cost effectiveness of content placement using placement optimization and content placement without the use of placement optimization.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

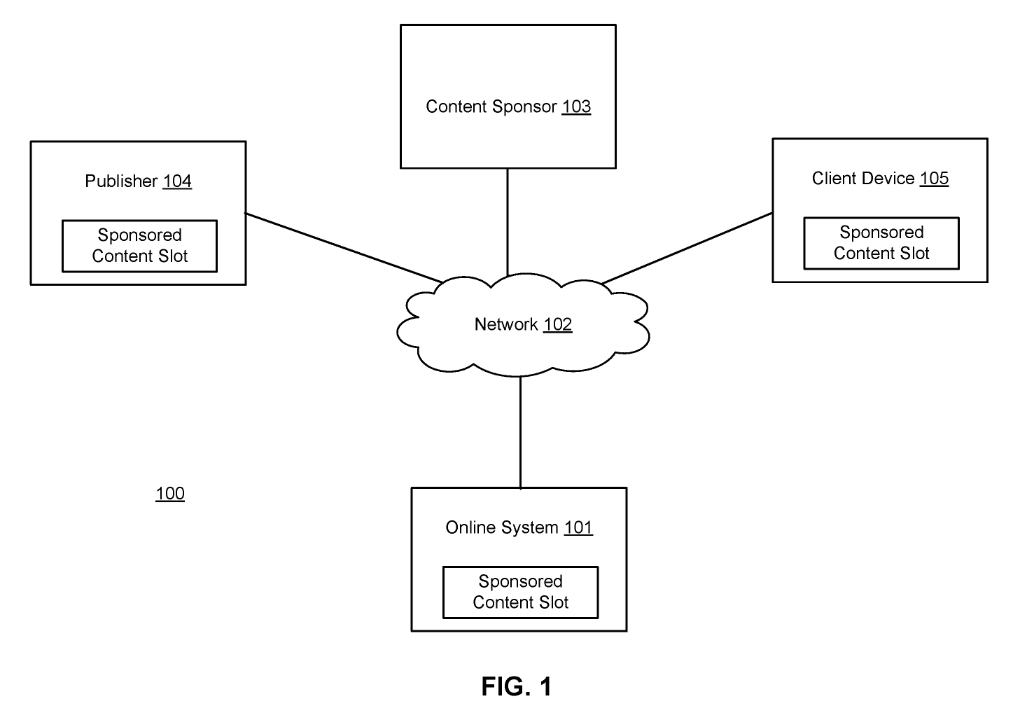

FIG. 1 is a block diagram of a system environment 100 for an online system 101. The system environment 100 shown by FIG. 1 comprises the online system 101, a network 102, one or more content sponsors 103, one or more publishers 104, and one or more client devices 105. In alternative configurations, different and/or additional components may be included in the system environment 100. For example, the online system 101 is a social networking system, a content sharing network, or another system providing content to users.

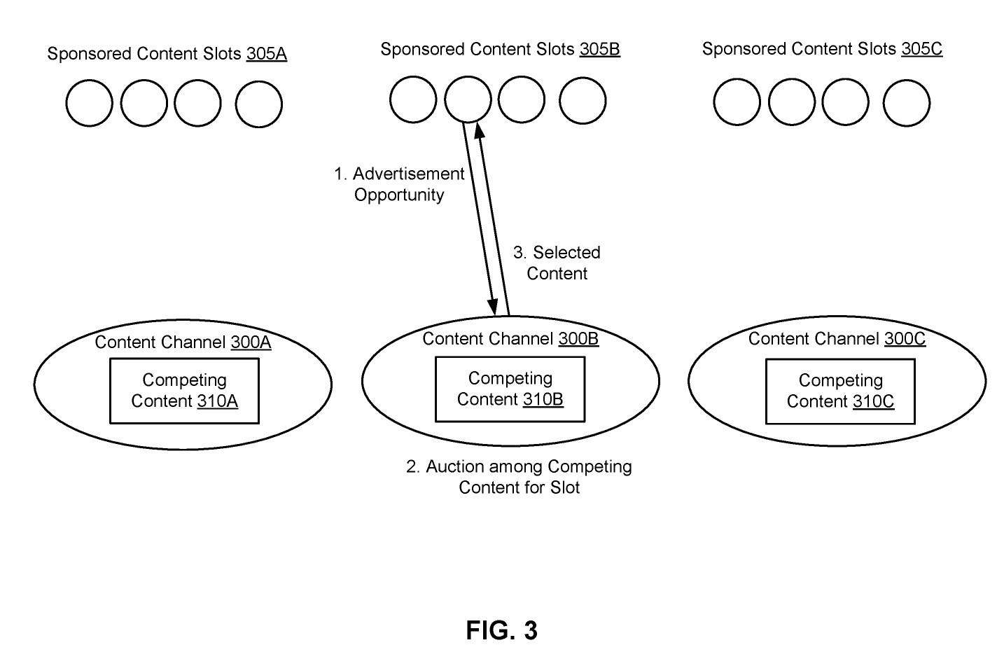

One or more content sponsors 103 may be communicatively connected the network 102 for communicating with the online system 101. In one embodiment, a content sponsor 103 provides sponsored content and other information to the online system 101. For example a content sponsor 103 may communicate information to the online system 101 about the sponsored content or the subject of the promotion by the content, such as content or information about an application provided by the content sponsor 103. Examples of sponsored content include text, image, audio, video, or any other suitable data that can be presented to a user. In various embodiments, the sponsored content also specifies a page of content for a user to be directed to after interacting with the sponsored content. For example, a sponsored content item includes a landing page specifying a network address of a page of content to which a user's device is directed when the sponsored content item is accessed. In some embodiments, sponsored content provided to the online system 101 by one or more content sponsors 103 is displayed at sponsored content slots of the online system 101, a publisher 104, and/or a client device 105. In further embodiments, content sponsors 103 compete with one another to have their content items displayed at the sponsored content slots of the online system 101, the publisher 104, and the client device 105. For example, content sponsors 103 may provide the online system 101 with a bid price that can be used during an auction to determine which content sponsor 103 will have their content displayed in a sponsored content slot. As another example, content sponsors 103 may provide the online system 101 with a bid price that can be used during all auctions on a particular channel. Such embodiments are described in greater detail with regard to FIG. 3.

The client devices 105 are one or more computing devices capable of receiving user input as well as transmitting and/or receiving data via the network 102. In one embodiment, a client device 105 is a computer system such as a desktop or a laptop computer. Alternatively, a client device 105 may be a device having computer functionality, such as a personal digital assistant (PDA), a mobile telephone, a smartphone, or another suitable device. A client device 105 is configured to communicate via the network 102. In one embodiment, a client device 105 executes an application allowing a user of the client device 105 to interact with the online system 101. For example, a client device 105 executes a browser application to enable interaction between the client device 105 and the online system 101 via the network 102. In another embodiment, a client device 105 interacts with the online system 101 through an application programming interface (API) running on a native operating system of the client device 105, such as IOS® or ANDROID™. In some embodiments, sponsored content provided by the online system 101 to the client device 105 is displayed in sponsored content slots on the client device 105.

The client devices 105 are configured to communicate via the network 102, which may comprise any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 102 may be represented using any suitable format, such as hypertext markup language (HTML) or extensible markup language (XML). In some embodiments, all or some of the communication links of the network 102 may be encrypted using any suitable technique or techniques.

One or more publishers 104 may also be coupled to the network 102 for communicating with the online system 101. Publishers 104 may be social networking systems, content sharing networks, or other systems providing content to users. Specifically, a publisher 104 hosts content at a site run by the publisher 104 and/or via an application provided by the publisher 104. Users access the content hosted by the publisher 104. In some embodiments, the content hosted by the publisher 104 includes a display location for sponsored content provided by outside parties, such as the online system 101. This display location for sponsored content placement is known as a sponsored content slot. When a sponsored content slot appears and is available for placement of sponsored content, the publisher 104 requests sponsored content from the online system 101 to fill the available sponsored content slot. Finally, the publisher 104 receives sponsored content from the online system 101 to display at the sponsored content slot.

### DETAILED DESCRIPTION

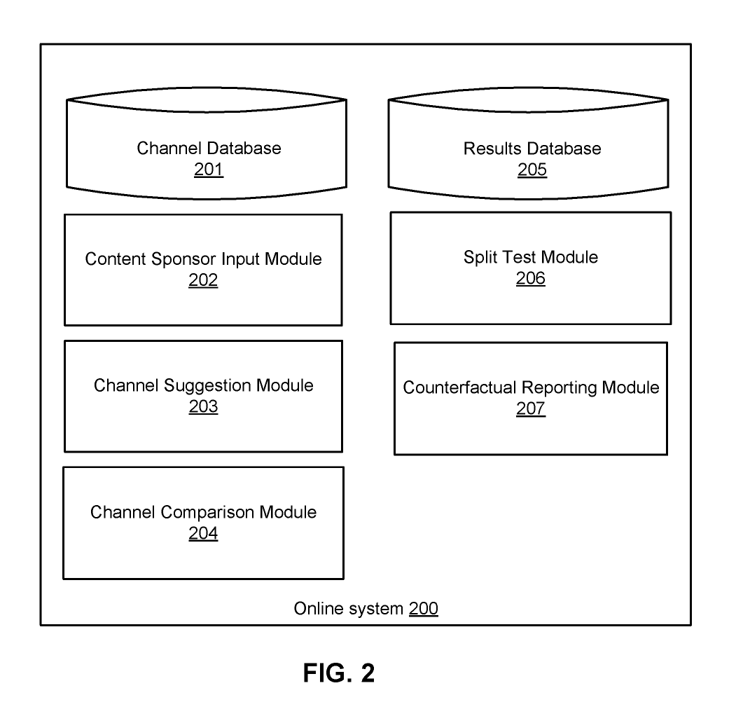

FIG. 2 is a block diagram of an embodiment 200 of the online system 101. The online system 200 shown in FIG. 2 includes a channel database 201, a content sponsor input module 202, a channel suggestion module 203, a channel comparison module 204, a results database 205, a split test module 206, and a counterfactual reporting module 207. In other embodiments, the online system 200 may include additional, fewer, or different components for various applications. Conventional components such as network interfaces, security functions, load balancers, failover servers, management and network operations consoles, and the like are not shown so as to not obscure the details of the system architecture.

The channel database 201 of the online system 200 stores channel objects. A set of sponsored content slots are selected for a channel. Sponsored content slots may be grouped into channels by the online system 200. A sponsored content slot is a location at which sponsored content may be displayed. As depicted in FIG. 1, sponsored content slots may be embedded within publishers 104, client devices 105, or even on the online system 101 itself. Specifically, as described above, content hosted by a publisher 104, a client device 105, and the online system 101 may include sponsored content slots that are available to display sponsored content from an outside system. For example, content hosted by a publisher 104 may include sponsored content slots available to be filled with content received from the online system 101. Sponsored content slots that are members of a channel may or may not be of the same type or origin. For example, in one embodiment, a channel may comprise sponsored content slots from a single publisher 104 such as a website. In another embodiment, a channel may comprise sponsored content slots from multiple, diverse publishers 104 and client devices 105. In a further embodiment, a channel may comprise sponsored content slots of the online system 101.

A channel also has a number of active sponsored content objects competing to be displayed at one or more of the sponsored content slots associated with that channel. As described below with regard to the content sponsor input module 202, content sponsors 103 may initiate content campaigns in which the sponsored content is placed to slots associated with one or more channels of the channel database 201, the ultimate goal being display of the sponsored content in the sponsored content slots associated with the one or more channels.

The content sponsor input module 202 receives content campaign requests from one or more content sponsors 103. A content campaign request is a request to display content at one or more sponsored content slots of one or more channels stored by the channel database 201. A content campaign request includes one or more of sponsored content, a bid price, targeting criteria, and any additional parameters. In some embodiments, a content campaign request also includes a total budget for the content campaign. The total budget indicates the total amount of money the content sponsor 103 will spend on bidding to display their sponsored content at the one or more sponsored content slots.

A sponsored content item specified by a content campaign may be any type of content including but not limited to titles, text data, image data, audio data, video data, landing pages, or any other information. A bid price included in a content campaign request is used to determine an expected value, such as monetary compensation, provided by a content sponsor to the online system 200 if the sponsored content included in the content campaign is displayed at a sponsored content slot, if the sponsored content receives a user interaction when displayed, or if any suitable condition is satisfied when the sponsored content is displayed. For example, the bid price included in a content campaign specifies a monetary amount that the online system 200 receives from a content sponsor that provided the sponsored content to the online system 200 if the content item is displayed. In some embodiments, the expected value to the online system 200 of presenting the sponsored content may be determined by multiplying the bid price by a probability of the content item being accessed by a user. In further embodiments the bid and the expected value to the online system 200 may differ according to the channel on which the sponsored content is competing.

In embodiments in which multiple content sponsors are competing to have their content displayed at sponsored content slots associated with a given channel, bid prices can be used to determine which content will be displayed. For example, in some embodiments, when an opportunity for displaying sponsored content arises for a slot, an auction occurs for sponsored content associated with the channel associated with that slot. The sponsored content associated with the highest bid price wins the auction and is subsequently displayed at the slot. One embodiment of this process of sponsored content selection will be described further with regard to FIG. 3 below.

A content campaign may include targeting criteria specified by the content sponsor that provided the content campaign to the online system 200. Targeting criteria specify one or more characteristics of users eligible to be presented with the sponsored content. For example, targeting criteria are used to identify users having user profile information, connections, or actions satisfying the targeting criteria. Hence, targeting criteria allow the online system 200 to simplify distribution of sponsored content to users having specific characteristics. The use of targeting criteria in selection of sponsored content will be described further with regard to FIG. 3 below.

In one embodiment, targeting criteria may specify actions or types of connections between a user and another user or object of the online system 200. Targeting criteria may also specify interactions between a user and objects performed external to the online system 200, such as on a website associated with a content sponsor 103, a publisher 104, or a client device 105. For example, targeting criteria identifies users that have taken a particular action, such as sent a message to another user, used an application, joined a group, left a group, joined an event, generated an event description, purchased or reviewed a product or service using an online marketplace, requested information from a content sponsor 103, installed an application, or performed any other suitable action. Including actions in targeting criteria allows users to further refine users eligible to be presented with content items. As another example, targeting criteria identifies users having a connection to another user or object or having a particular type of connection to another user or object.

Additional criteria may also be specified by a content sponsor in a content campaign. In some embodiments, content campaigns may include an objective identifying an action that the content sponsor desires users to perform when presented with a sponsored content item. Example objectives include: installing an application associated with a content item, indicating a preference for a content item, sharing a content item with other users, interacting with an object associated with a content item, or performing any other suitable interaction. As sponsored content is displayed at sponsored content slots, the online system 200 logs interactions between users presented with the sponsored content or with objects associated with the sponsored content. Additionally, the online system 200 may receive compensation from the content provider as users perform interactions with the sponsored content item that satisfy the objective included in the content campaign.

User fulfillment of targeting criteria can be derived in a variety of ways. In one embodiment, user information can be derived from information stored on the online system 200. Such information may include a user profile, an action log describing actions of the user, connections of the user to other entities of the online system 200, and additional sources of information. In yet a further embodiment, user information can be predicted based on a location of the sponsored content slot. For example, if a sponsored content slot is located on a webpage of a local dog shelter, the channel associated with the sponsored content slot may predict that users viewing the sponsored content slot are dog lovers, and provide an advertisement for delicious dog treats for display at the sponsored content slot.

In another embodiment, the online system 200 uses a tracking pixel or piece of HTML code placed on third-party websites to monitor users visiting the websites that have not opted out of tracking. A tracking pixel is included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an iframe, or other suitable object being created for third party pages. When a user's browser loads a page having the tracking pixel, the tracking pixel results in the user's browser attempting to retrieve the content for that pixel, and the browser contacts the online system to retrieve the content. The request sent to the online system, however, actually includes various data about the user's actions taken on the third party website. The third party website can control what data is sent to the online system. For example, the third party system may include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party's user identifier (UID) for the user, contact information for the user, etc.), and other data. In some embodiments, a cookie set by the online system can also be retrieved by the online system, which can include various data about the user, such as the online systems' UID for the user, information about the client device and the browser, such as the Internet Protocol (IP) address of the client device, among other data. Tracking can also be performed on mobile applications of content providers by using a software development kit (SDK) of the online system or via an application programming interface (API) of the online system to track events (e.g., purchases) that occur by users on the content provider's app that are reported to the online system. This information obtained through user tracking can better enable user-specific content to be displayed to the user at the visited sponsored content slot.

FIG. 3 illustrates the process of selecting sponsored content for display in a sponsored content slot, in accordance with one embodiment. As depicted in FIG. 3, there are three unique content channels: a content channel 300A, a content channel 300B, and a content channel 300C. Each content channel is associated with a unique set of sponsored content slots. For example, the content channel 300A is associated with sponsored content slots 305A, the content channel 300B is associated with sponsored content slots 305B, and the content channel 300C is associated with sponsored content slots 305C. As mentioned above, the sponsored content slots associated with a given channel do not need to be of the same type or origin. Specifically, sponsored content slots associated with a given channel can be located on a plurality of different publishers 104, client devices 105, and/or the online system 101. Furthermore, sponsored content slots associated with a given channel may be viewed by a plurality of different users. In other words any sponsored content slots can be associated with any channel as deemed appropriate by the online system 200.

The process of selecting sponsored content for display in a sponsored content slot begins when an advertisement opportunity arises at a sponsored content slot associated with a channel. In some embodiments, an advertisement opportunity arises when a new user visits the sponsored content slot. In alternative embodiments, an advertisement opportunity arises when content has been displayed at the sponsored content slot for a specified length of time. In further embodiments, an advertisement opportunity arises when a user requests display of alternative content at the sponsored content slot. When the advertisement opportunity occurs, the client device or publisher of the sponsored content slot requests content from the channel to be placed in sponsored content slot.

As mentioned above, each content channel is associated with a number of active sponsored content objects specified by content campaigns and competing to be displayed in a sponsored content slot. Specifically, content becomes associated with a channel when a sponsor of the content initiates a content campaign and specifies the content channel as a target of the content campaign. For example, content channel 300A is temporarily associated with competing content 310A, content channel 300B is temporarily associated with competing content 310B, and content channel 300C is temporarily associated with competing content 301C. The content sponsor targets the channel with the content in the hopes that the content will be displayed at one or more of the sponsored content slots associated with the channel. Content objects that are active in the same content channel but with different campaigns are referred to as ‘competing content’ because the content objects are in competition with one another for display at sponsored content slots associated with the channel.

In some embodiments, when a sponsored content slot requests content from the channel with which it is associated, the sponsored content slot also provides information to the channel about the user for whom the requested content is intended. This user information, along with user targeting criteria associated with campaign content, is used by the channel to efficiently select content for display to the user at the sponsored content slot. As an example, consider a content campaign that targets a channel with a coupon for pet food. Further assume that the content campaign specifies targeting criteria that indicates that only users identified as having a pet should be presented with the coupon. If a user identified as having a pet visits a sponsored content slot associated with the channel, the coupon may be displayed at the sponsored content slot to the user. On the other hand, if a user that has not been identified as having a pet visits the sponsored content slot associated with the channel, the channel will not select the coupon to be displayed at the sponsored content slot.

In further embodiments, users may be targeted for content presentation on an individual-by-individual basis. For example, a company may provide a list of encrypted or hashed user information to permit the certain hashed user information to permit the online system to match its hashed information with known user information of the online system 200.

Recall that content sponsors target channels in the hopes that content provided by their campaign will be displayed at one or more of the sponsored content slots associated with the channel. However, targeting a channel with the content does not guarantee that the content will be displayed at one or more of the sponsored content slots associated with the channel. Rather, because a plurality of content sponsors may all target the same channel with their own content, content associated with the channel must compete to be displayed at one or more of the sponsored content slots associated with the channel. In the embodiment depicted in FIG. 3, content competes to be displayed through participation in an auction.

As described above with regard to FIG. 2, channel-associated content associated that is eligible for display at a sponsored content slot associated with the channel enters an auction that uses bid prices associated with the content to determine which content will be displayed. In various embodiments, the online system 200 determines an expected value associated with various content items based on their bid prices and selects content items associated with a maximum expected value or associated with at least a threshold expected value for presentation. An expected value associated with a content item represents an expected amount of compensation to the online system 200 for presenting the content item. For example, the expected value associated with a content item is a product of the ad request's bid amount and a likelihood of the user interacting with the content item. The online system 200 may rank content items based on their associated bid prices and select content items having at least a threshold position in the ranking for presentation to the user. In some embodiments, the online system 200 ranks both content items not associated with bid prices and content items associated with bid prices in a unified ranking based on bid prices and measures of relevance associated with content items. Based on the unified ranking, the online system 200 selects content for presentation to the user. The content that wins the auction and is subsequently displayed at the sponsored content slot. Selecting content items associated with bid prices and content items not associated with bid prices through a unified ranking is further described in U.S. patent application Ser. No. 13/545,266, filed on Jul. 10, 2012, which is hereby incorporated by reference in its entirety.

Turning back to FIG. 2, the channel suggestion module 203 proposes one or more channels to be targeted by a content sponsor's content campaign. As previously mentioned, a channel represents a set of sponsored content slots. Each channel is also temporarily associated with sponsored content to be displayed at the sponsored content slots. Thus the channel suggestion module 203 suggests a set of sponsored content slots at which to display the sponsored content of a content campaign.

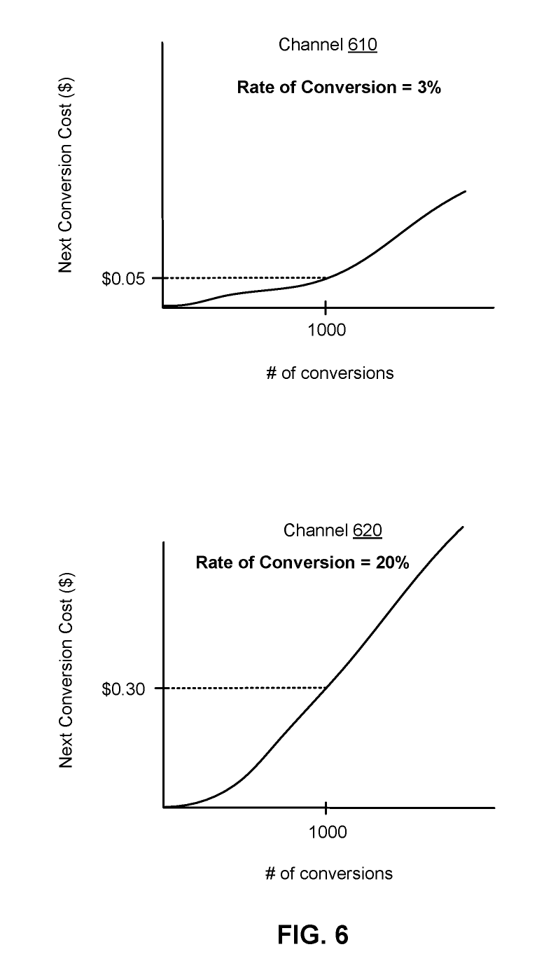

The channel suggestion module 203 proposes target channels for a content campaign to maximize cost-effectiveness of the content campaign given a total budget of the content campaign. Cost-effectiveness of a content campaign can be based upon campaign objectives specified by the online system 200, or campaign objectives specified by the content sponsor 103 via the content sponsor input module 202. The channels suggested by the channel suggestion module 203 can be approved or rejected by the content sponsor 103 via the content sponsor input module 202. The operation of the channel suggestion module 203 with specific regard to the maximization of cost-effectiveness of a content campaign is described in greater detail with regard to FIG. 6.

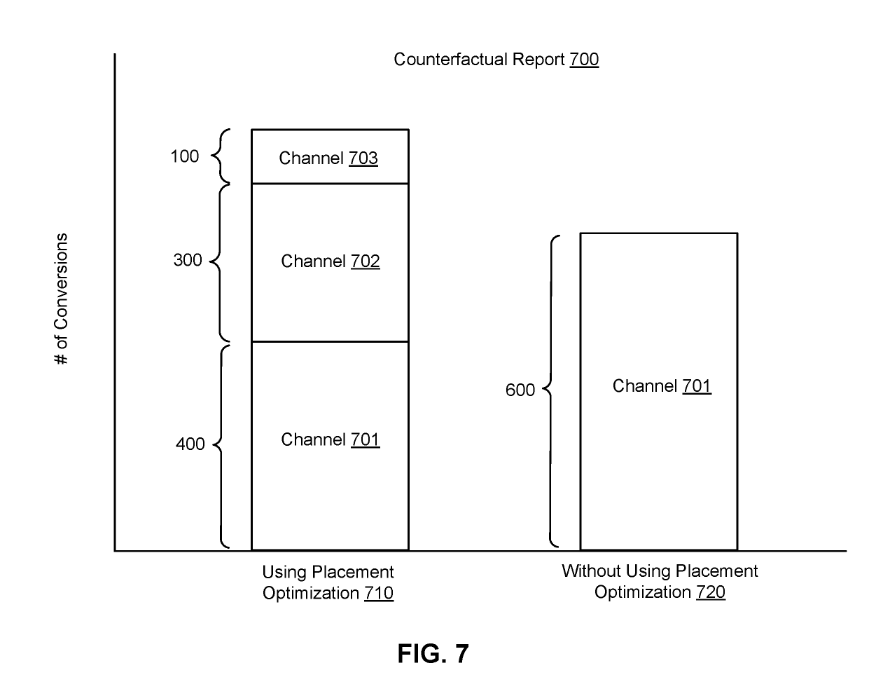

Based on the reaction of the content sponsor 103 to the channel proposals from the channel selection module 203, the channel comparison module 204 generates comparisons between different channel selections. Specifically, if one or more of the channels proposed by the channel suggestion module 203 are rejected, the channel comparison module 204 generates comparisons of content performance on different channels. The channel comparison module 204 presents an alert to the content sponsor 103 including data describing predicted results of altering the selection of channels targeted by the content campaign. In some embodiments, the alert may predict the amount of potential conversions that will be lost as a result of altering the channels targeted by the campaign. In an alternative embodiment, the alert may predict a discrepancy between objective fulfillment as a result of altering the channels targeted by the campaign. In some embodiments, the alert comprises a counterfactual report prepared by the counterfactual reporting module 207. Such embodiments are discussed in further detail below with regard to FIG. 7.

The results database 205 contains data describing both the inputs and the results of previously completed content campaigns. Results of content campaigns with inputs (such as campaign objectives, target users, and targeted sponsored content slots) similar to that of the current content campaign can be used predict the results of the current content campaign. The alert analysis performed by the channel comparison module 204 uses data form the results database 205. Some embodiments of the data stored in the results database 205 and used by the channel comparison module 204 are discussed further with regard to FIG. 6.

Based on the alert provided by the channel comparison module 204, the content sponsor 103 may either proceed with the content campaign using the suggested channels proposed by the channel suggestion module 203, or proceed with the campaign using an alternative set of channels. When the content sponsor 103 ignores the alert from the channel comparison module 204 and proceeds with the campaign using the alternative set of channels, the split test module 206 initiates operation.

The split test module 206 provides the content sponsor with the option to run a split test to compare the results of a campaign using the suggested channels chosen by the channel suggestion module 203, to the results of a campaign using the alternative set of channels chosen by the content sponsor 103. A split test is an experiment in which a campaign budget specified by the content sponsor 103 via the content sponsor input module 202 is split into two or more portions, with each portion being used for a different campaign. Specifically, one portion of the budget is used to implement the campaign targeting the suggested channels, and one or more additional portions of the budget are used to implement one or more campaigns targeting the alternative set of channels. In some embodiments, the users targeted by separate campaigns are also split into portions during the split test to ensure that the competing campaigns are not also competing for the same users.

Following completion of the separate campaigns, the split test module 206 provides a report containing the results of the split test to the content sponsor 103. Based on the result report provided by the split test module 206, the content sponsor 103 can determine first hand which set of targeted channels maximizes cost-effectiveness of the campaign.

In some embodiments, the split test result report may depict a discrepancy between the desired results of the separate campaigns. In an alternative embodiment, split test result report may depict a discrepancy between the objectives fulfilled by the separate campaigns. In a further embodiment, the split test result report may depict any alternative descriptor of discrepancy of cost-effectiveness between the separate campaigns. In some embodiments, the result report comprises a counterfactual report prepared by the counterfactual reporting module 207. Such embodiments are discussed in further detail below with regard to FIG. 7. Results from the split test are also stored in the results database 205 for use in future campaign comparisons by the channel comparison module 204.

The counterfactual reporting module 207 produces a report containing a visual comparison of results for the content campaign targeting the suggested channels and results for the one or more content campaigns targeting the one or more alternative sets of channels. A counterfactual report can be generated at any phase in the process of designing or implementing a content campaign. In one embodiment, a counterfactual report may be generated following completion of a split test by the split test module 206. In another embodiment, a counterfactual report may present an alert generated by the channel comparison module 204. In yet another embodiment, a counterfactual report may be generated following the completion of a content campaign that that did not use a split test, but targeted only the alternative set of channels as specified by the content sponsor 103.

Depending upon the objective of the content campaign, the counterfactual reporting module 207 may use data from various sources to predict the likely cost and conversion results of providing sponsored content to different channels by differentially allocating portions of the total campaign budget to the different channels. Predicted results for simulated campaigns may use data from the results database 205 as described above. For example, data sourced from individual auctions that have already occurred may be used to predict results of future auctions. In some embodiments, results for implemented campaigns may use pixel tracking as described above. For example, if a user that is presented with sponsored content at a sponsored content slot purchases the product advertised (possibly at some point later, and possibly on a different device), using pixel tracking the online system 200 can link the purchase to the sponsored content originally shown at the sponsored content slot. Thus, the online system 200 can include this data in its counterfactual reporting to the content sponsor 103.

In one embodiment, a counterfactual report may display a comparison of a total number of conversions achieved using a given campaign budget when sponsored content is provided to a first set of channels selected by the content sponsor 103 versus a total number of conversions achieved using the same campaign budget when the sponsored content is provided to a second set of channels proposed by the online system 101. To produce such a counterfactual report, the counterfactual reporting module 207 determines an expected marginal cost per conversion for the first set of channels based on an allocation of the total campaign budget to each channel of the first set of channels, and given targeting criteria specified by the content sponsor 103. Then, using the total budget for the content campaign, the counterfactual reporting module 207 re-allocates portions of the total budget to each channel of the second set of channels to reach the same expected marginal cost per conversion obtained using the first set of channels. Finally, the counterfactual reporting module 207 determines how many conversions are expected for the second set of channels based on the re-allocation of the total budget. This number of expected conversions for the second set of channels is compared to a number of expected conversions for the first set of channels. In one embodiment, to determine the number of expected conversions for a channel, the counterfactual reporting module 207 divides the portion of the total budget allocated to the channel by the expected marginal cost per conversion for the channel. Then, to determine the number of expected conversions for a set of channels, the expected number of conversions for each channel of the set of channels are summed together.

Display of counterfactual reports to a content sponsor 103 by the counterfactual reporting module 207 aims to allay any misconceptions regarding the cost-effectiveness of targeting one set of channels as opposed to another set of channels during a content campaign. Misconceptions regarding the cost-effectiveness of targeting certain channels commonly arise when content sponsors 103 compare only overall rates of objective fulfillment for channels. As an example, assume the overall rate of objective fulfillment when targeting a channel A is lower than the overall rate of objective fulfillment when targeting a channel B. This simple comparison may lead a content sponsor 103 to spend its entire campaign budget targeting only the channel B, and not the channel A. The downfall in this situation is that the content sponsor 103 does not take into account the rate at which the cost of objective fulfillment increases as objectives are fulfilled. In other words, the slope of the cost-objective fulfillment graph is not considered. In many cases, as objectives are fulfilled on the channel B, incremental objective fulfillment becomes exponentially more expensive, rendering continued targeting of the channel B more and more cost-ineffective. Often times it is more cost-effective to target a few, low-cost users on multiple channels, rather than all low-cost and high-cost users on a single channel. In other words, it may be more cost-effective to pursue inexpensive objective-fulfillment on multiple channels, than to pursue increasingly expensive objective-fulfillment on a single channel. The purpose of counterfactual report presentation is to overcome such common misconceptions and promote cost-effective campaigning in a visual and easily-comprehendible format.

The motivation behind counterfactual reporting is further described with regard to FIG. 6, and one example of a counterfactual report is illustrated and described with regard to FIG. 7.

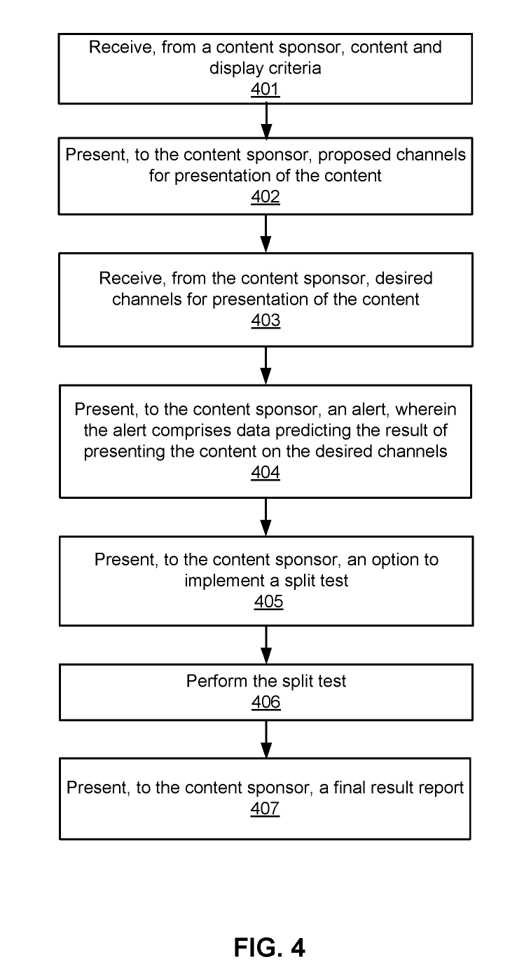

FIG. 4 is a flow chart of a method for optimizing placement of sponsored content, in accordance with an embodiment. In other embodiments, the method may include different and/or additional steps than those shown in FIG. 4. Additionally, steps of the method may be performed in different orders than the order described in conjunction with FIG. 4 in various embodiments.

First, the online system 200 receives 401, from a content sponsor, sponsored content and display criteria. As noted above, examples of sponsored content include text, image, audio, video, or any other suitable data that can be presented to a user. In various embodiments, the sponsored content also specifies a page of content. Display criteria may include specifications of a campaign budget, a bid price, user targeting criteria, and any additional parameters used to facilitate presentation of the content to a user.

Next the online system 200 presents 402, to the content sponsor, proposed channels for presentation of the content. As previously described, a channel comprises a set of sponsored content slots. Thus step 402 involves selecting a set of sponsored content slots for display of the content specified in step 401. The channels proposed in step 402 are selected such that cost-effectiveness of the content campaign is maximized. Cost-effectiveness of a content campaign can be predicted using campaign objectives specified by the online system 200, or upon campaign objectives specified by the content sponsor in step 401. Data used to predict the cost-effectiveness of targeting certain channels is sourced from a database of the online system 200 that contains results from previously conducted content campaigns.

The online system receives 403, from the content sponsor, desired channels for presentation of the content. The desired channels specified by the content sponsor may be the proposed channels suggested by the online system 200 in step 402, or they may be an alternative set of channels as decided upon by the content sponsor.

In the event that the content sponsor rejects some of the proposed channels in step 403 in favor of an alternative set of channels, step 404 is initiated. The online system 200 presents 404, to the content sponsor, an alert, wherein the alert comprises data predicting the result of presenting the content on the desired channels. In some embodiments, the alert may predict the amount of money that will be lost as a result of altering the channels targeted by the campaign. In an alternative embodiment, the alert may predict a discrepancy between objective fulfillment as a result of altering the channels targeted by the campaign. In a further embodiment, the alert may display a prediction of any alternative descriptor of cost-effectiveness. In some embodiments, the alert comprises a counterfactual report prepared by the counterfactual reporting module 207. The data used in the alerts is sourced from the database of the online system 200 that contains results from previously conducted content campaigns. Results from completed campaigns that were similar to the current campaign are used to predict the result of the current campaign.

Next, the content sponsor is presented 405 with an option to implement a split test. In some embodiments, step 405 occurs only if the content sponsor does not heed the alert provided in step 404, and opts to continue targeting the alternative set of channels, as opposed to the channels proposed by the online system in step 402. A split test is an experiment in which the campaign budget specified by the content sponsor in step 401 is split into two or more portions, with each portion being used for a different campaign. Specifically, one portion of the budget is used to implement the campaign targeting the channels proposed in step 402, and one or more additional portions of the budget are used to implement one or more campaigns targeting the alternative set of channels. In some embodiments, the users targeted by separate campaigns are also split into portions during the split test to ensure that the competing campaigns are not also competing for the same users.

Depending on the reaction of the content sponsor to the option to implement a split test in step 405, the split test is performed 406. Finally, a final result report is presented 407 to the content sponsor. In some embodiments in which the split test was performed 406, the final result report depicts the results of the split test. In some embodiments in which a split test was not implemented, the final result report may compare the results of implementing the campaign targeting the alternative set of channels selected in step 403, to predicted results of implementing the campaign targeting the set of channels proposed in step 402. In embodiments in which the content sponsor chose to target the channels suggested in step 402, the result report may simply depict the results received.

In some embodiments, the results depicted may be the amount of money earned by one or more content campaigns. In an alternative embodiment, the results depicted may be the quantity of objectives fulfilled by the one or more content campaigns. In a further embodiment, results depicted may comprise any alternative descriptor of cost-effectiveness of the campaigns. In embodiments in which results of one or more campaigns are compared, the result report may comprise a counterfactual report. A counterfactual report is a visual and easily-comprehensible comparison of results that may be used to ablate any misconceptions regarding the cost-effectiveness of targeting one set of channels as opposed to another set of channels during a content campaign.

The final results report generated in step 407 may include data from a variety of sources. Predicted results for simulated campaigns may use data from the results database of the online system 200. In some embodiments, results for implemented campaigns may use pixel tracking as previously described with regard to FIG. 3.

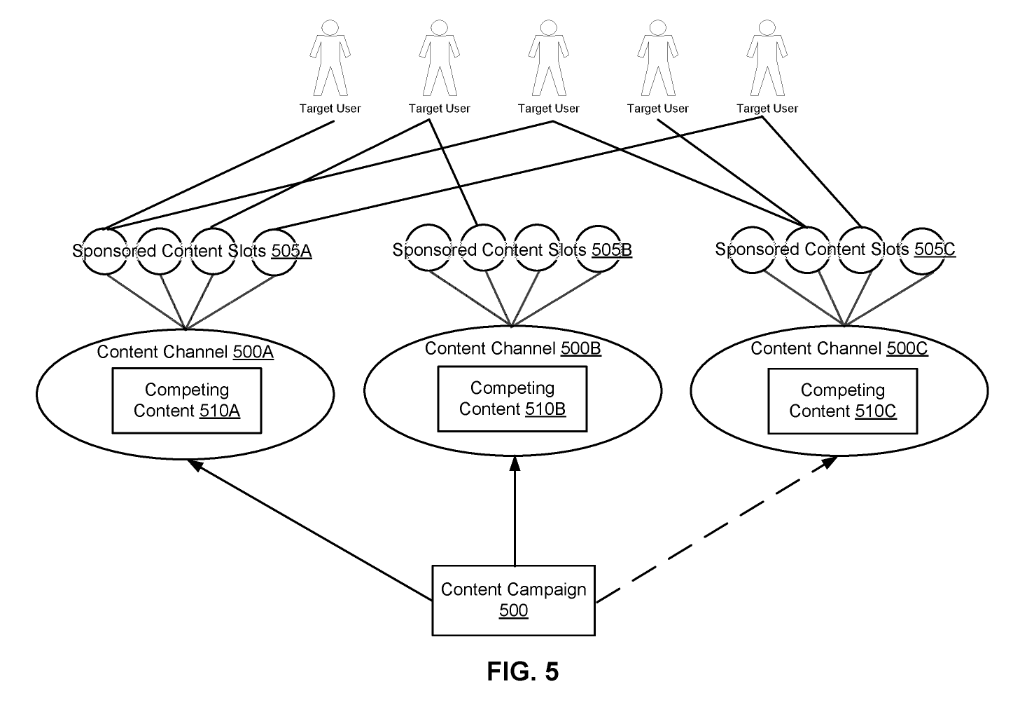

FIG. 5 is a diagram illustrating implementation of a content campaign 500, in accordance with one embodiment. The content campaign 500 may be initiated by a content sponsor with the end goal of displaying sponsored content at one or more sponsored content slots in view of one or more target users. As discussed with regard to FIG. 4, the first step in the campaign process is to provide content to one or more content channels (e.g., content channel 500A, content channel 500B, and content channel 500C). Note that the dotted arrow shown in FIG. 5 indicates that the content sponsor of the content campaign 500 chose not to target the content channel 500C. On the other hand, the filled arrows directed at the content channel 500A and the content channel 500B indicate that the content sponsor of the content campaign 500 affirmatively chose to target those two channels. As described with regard to FIGS. 2-4, there are multiple methods through which channels are chosen to be targeted by a content campaign. In some embodiments the content sponsor selects the channels with input from the online system 200 while in other embodiments the content sponsor selects the channels to target without input from the online system 200.

When targeting the content channel 500A and the content channel 500B, the content campaign 500 introduces content to a pre-existing pool of competing content. Specifically, content channel 500A is associated with competing content 510A, content channel 500B is associated with competing content 510B, and content channel 500C is associated with competing content 510C. Pre-existing pools of competing content may comprise content items received from alternative content campaigns. Nonetheless, all content associated with a content channel, including the content associated with the content campaign 500, is competing for display at one or more sponsored content slots associated with the channel. Specifically, the competing content 510A associated with the content channel 500A is competing to be displayed at one or more of the sponsored content slots 505A, the competing content 510B associated with the content channel 500B is competing to be displayed at one or more of the sponsored content slots 505B, and content 510C associated with the content channel 500C is competing to be displayed at one or more of the sponsored content slots 505C.

Sponsored content slots are accessed by individuals known as target users. A target user may access multiple sponsored content slots that may be associated with one or more different content channels. Furthermore, a user's interactions with content at a sponsored content slot may differ depending upon the specific sponsored content slot, or upon the specific channel with which that sponsored content slot is associated.

When a target user accesses a sponsored content slot, the sponsored content slot is eligible to receive sponsored content from the pool of competing content of the channel with which the slot is associated. Furthermore, the content that is selected for display at the sponsored content slot is selected based on the characteristics of the target user that access the slot. In some embodiments, the content campaign 500 specifies one or more targeting criteria that are used to determine which target users to present the sponsored content to. In other words, the content campaign 500 specifies when sponsored content should compete to be displayed to a target user at a sponsored content slot.

When a sponsored content slot is accessed by a target user and becomes eligible to display sponsored content from its associated channel, the online system 200 determines information about the target user in order to determine which targeting criteria associated with which competing content are fulfilled by the target user. If the user satisfies at least a specified threshold of targeting criteria indicated by a content object, that content object becomes eligible for display to the target user at the sponsored content slot. Content whose targeting criteria are not satisfied by the target user are not considered in the competition for display at the sponsored content slot.

Once all competing content objects whose targeting criteria have been deemed as satisfied by the target user have been determined, these competing content objects engage in an auction to determine which single content object will be displayed to the target user at the sponsored content slot. As well as providing user targeting criteria, the content campaign 500 (as well as all other content campaigns) may specify a bid price. This bid price is then used in the auction mentioned above to determine which content item will be displayed at the sponsored content slot. The content item associated with the highest bid price wins the auction, and the content item is subsequently displayed at the sponsored content slot for access by the target user in the hopes that the target user will complete a desired objective.

FIG. 6 illustrates the cost effectiveness of sponsored content placement on two different channels in accordance with one embodiment. Specifically, two identical content campaigns are simulated for different channels. A first content campaign displays the sponsored content on a channel 610, and a second content campaign displays the sponsored content a channel 620. Below the channel label for both graphs, bolded text indicates the average rate of conversion for the corresponding channel. The rate of conversion represents the proportion of target users that engage in an objective specified by the campaign after being presented with the sponsored content during the content campaign. In other words, the rate of conversion indicates the success of the sponsored content at achieving its objective when presented to target users on a given channel. As described with regard to FIG. 2, objectives may include: installing an application associated with a content item, indicating a preference for a content item, sharing a content item with other users, interacting with an object associated with a content item, or performing any other suitable interaction.

As seen in FIG. 6, the rate of conversion for channel 610 is 3% and the rate of conversion for channel 620 is 20%. This means that the sponsored content is more often successful at achieving its objective when presented to users on channel 620, than when presented to users on channel 610. Based on the rate of conversion alone, sponsors may assume that channel 620 is the more effective outlet for content presentation. And as a result of this assumption, content sponsors may indicate within a content campaign that they wish to target only channel 620 with their content. However, this may be a problematic assumption because rate of conversion does not account for the cost of each conversion. Including conversion costs in the analysis of channel performance enables a more accurate determination of which channels are the most cost-effective for use in a content campaign. Stated another way, although the rate of conversion may be lower, the cost to achieve a conversion may also be lower. In addition, users may have different predicted rates of performing a conversion, and the cost-per-conversion may increase as the total number of content placements in a channel decreases because each placement may occur to users with decreasing predicted rates of conversion.

To include conversion costs in the analysis of channel performance, FIG. 6 also contains graphs depicting the cost of incremental conversions for content campaigns on the channel 610 and on the channel 620. In other words, based on the number of campaign objectives previously fulfilled on a given channel, the cost of fulfilling the next objective is indicated. As an example, the graphs corresponding to channel 610 and channel 620 depict the cost of the cost of fulfilling objective number one-thousand-and-one. Fulfilling objective number one-thousand-and-one costs $0.05 on channel 610 and $0.30 on channel 620. In other words, after fulfilling one-thousand objectives, fulfillment of the next objective will cost the campaign $0.05 on channel 610 and $0.30 on channel 620.

Thus while the rate of conversion of the channel 620 is greater than that of the channel 610, the cost of each conversion increases at a much faster rate on the channel 610 than on the channel 620. Based on this information, content sponsors may reevaluate the portion of the campaign budget that is allocated to displaying content each channel. For example, in the scenario displayed in FIG. 6, a content sponsor may choose to allocate initial funds of the campaign budget to targeting channel 620, but after the cheapest conversions have been obtained on channel 620, the content sponsor may choose to allocate the remaining campaign budget to targeting channel 610 where conversions are less frequent, but also cost less.

The data depicted in FIG. 6 is one embodiment of the data stored by the results database 205, and used by the channel suggestion module 203 and the channel comparison module 204. Specifically, rate of conversion and incremental cost of conversion may be two of the data types used to predict and compare the cost effectiveness of running content campaigns targeting different sets of channels. In addition to these two data types, prediction of the cost effectiveness a content campaign may incorporate other factors. For example, cost effectiveness of a content campaign may depend upon profiles of target users, the channels targeted, or the specific sponsored content slots targeted. For example, target users may be more likely to engage with sponsored content when it is accessed via sponsored content slots located on a social media site, than when it is access via sponsored content slots located on a gaming application.

The graphs of FIG. 6 illustrate the differences between channels for channel selection. As noted previously, at first glance at the rates of conversion corresponding to the channels 610 and 620, content sponsors may decide to use an entire campaign budget to market solely to target users accessing sponsored content slots of channel 620. However, as the graphs depicting incremental costs of conversion indicate, it may be more cost effective to allocate a portion of the campaign budget to content display on channel 610 as well. In order to demonstrate this counterintuitive idea to content sponsors in an easily-understandable, visual format, counterfactual reporting may be employed.

FIG. 7 provides one embodiment of a counterfactual report 700 that compares cost effectiveness of content placement using placement optimization 710 and cost effectiveness of content placement without the use of placement optimization 720. Specifically the counterfactual report 700 is a bar chart comparing the number of conversions achieved for a content campaign that selected target channels using placement optimization 710 to the number of conversions achieved for the same content campaign that selected target channels without the use of placement optimization 720. Note that the campaigns are identical aside from the selection of targeted channels. Thus the campaign that used placement optimization 710 is assumed to have the same campaign budget as the campaign that did not use placement optimization 720.

FIG. 7 assumes that a single channel, a channel 701, was targeted in the campaign that did not use placement optimization 720. As depicted in FIG. 7, using the set campaign budget, a total of 600 conversions were achieved via target users of channel 701. On the other hand, three channels, the channel 701, a channel 702, and a channel 703, were targeted in the campaign that did use placement optimization 710. Using the same campaign budget used in campaign 720, the campaign 710 achieved a total of 800 conversions with a conversion breakdown as follows: 400 target users of channel 701 were converted, 300 target users of channel 702 were converted, and 100 target users of channel 703 were converted.

As the counterfactual report 700 illustrates, using the same overall campaign budget, the campaign that used placement optimization 710 in the selection of targeted channels achieved more conversions than the campaign that did not use placement optimization 720 when selecting targeted channels. Thus counterfactual reports such as the counterfactual report 700 may be useful in enabling content sponsors to improve cost effectiveness of content campaigns when presented during different steps in the campaign process.

Note that FIG. 7 illustrates only one embodiment of a counterfactual report 700. Alternative embodiments may be illustrated in an alternative format and may contain different sets of data. For example, in some embodiments, rather than illustrating the number of conversions achieved using a fixed budget, a counterfactual report may illustrate the total cost required to achieve a fixed number of conversions with and without the use of placement optimization.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, from the content sponsor by an online system selecting content for users, a campaign budget and a campaign objective for presenting one or more content items to users;
presenting, to the content sponsor, proposed channels for presentation of the content items;
receiving, from the content sponsor, desired channels for presentation of the content items, wherein the desired channels are not the same as the proposed channels;
determining predicted performance of the campaign with respect to the campaign objective and the campaign budget on the proposed channels and on the desired channels;
presenting, to the content sponsor, an alert of the predicted performance of the campaign;
presenting, to the content sponsor, an option to implement a split test, wherein the split test comprises allocating portions of the campaign budget to a first content campaign and a second content campaign, wherein the first content campaign presents the content on the proposed channels and the second content campaign presents the content on the desired channels;
implementing the first content campaign and the second content campaign;
presenting, to the content sponsor, one or more result reports.

2. The method of claim 1, wherein a channel comprises a set of locations at which the content will be displayed.

3. The method of claim 1, wherein the proposed channels for presentation of content are selected using data from previous content campaigns.

4. The method of claim 1, wherein the predicted performance of the campaign is determined based on data from previous content campaigns.

5. The method of claim 1, wherein the predicted performance of the campaign is determined based on an assumption that the campaign objective is maximization of downstream conversions.

6. The method of claim 1, wherein the predicted performance of the campaign comprises a discrepancy between costs of fulfillment of the campaign objective using the proposed channels and the desired channels.

7. The method of claim 1, wherein the predicted performance of the campaign comprises a discrepancy between magnitudes of fulfillment of the campaign objective using the proposed channels and the desired channels.

8. The method of claim 1, wherein the predicted performance of the campaign comprises a discrepancy between a combination of cost of fulfillment of the campaign objective and magnitude of fulfillment of the campaign objective using the proposed channels and the desired channels.

9. The method of claim 1, wherein the one or more result reports comprises a comparison of the first content campaign and the second content campaign implemented via the split test.

10. The method of claim 1, wherein the one or more result reports further comprise data indicating a discrepancy between costs of fulfillment of the campaign objective for the first content campaign and the second content campaign.

11. The method of claim 1, wherein the one or more result reports further comprise data indicating a discrepancy between magnitudes of fulfillment of the campaign objective for the first content campaign and the second content campaign.

12. The method of claim 1, wherein the one or more result reports further comprise data indicating a discrepancy between a combination of cost of fulfillment of the campaign objective and magnitude of fulfillment of the campaign objective for the first content campaign and the second content campaign.

13. The method of claim 1, wherein the one or more result reports further comprise a counterfactual report similar to the one shown in FIG. 7.

14. A non-transitory computer-readable medium having instructions for execution by a processor causing the processor to:
receive, from the content sponsor by an online system selecting content for users, a campaign budget and a campaign objective for presenting one or more content items to users;
present, to the content sponsor, proposed channels for presentation of the content items;
receive, from the content sponsor, desired channels for presentation of the content items, wherein the desired channels are not the same as the proposed channels;
determine predicted performance of the campaign with respect to the campaign objective and the campaign budget on the proposed channels and on the desired channels;
present, to the content sponsor, an alert, wherein the alert of the predicted performance of the campaign;
present, to the content sponsor, an option to implement a split test, wherein the split test comprises allocating portions of the campaign budget to a first content campaign and a second content campaign, wherein the first content campaign presents the content on the proposed channels and the second content campaign presents the content on the desired channels;
implement the first content campaign and the second content campaign;
present, to the content sponsor, one or more result reports.

15. The non-transitory computer-readable medium of claim 14, wherein a channel comprises a set of locations at which the content will be displayed.

16. The non-transitory computer-readable medium of claim 14, wherein the predicted performance of the campaign is determined based on data from previous content campaigns.

17. The non-transitory computer-readable medium of claim 14, wherein the one or more result reports comprises a comparison of the first content campaign and the second content campaign implemented via the split test.

18. The non-transitory computer-readable medium of claim 14, wherein the one or more result reports further comprise data indicating a discrepancy between costs of fulfillment of the campaign objective for the first content campaign and the second content campaign.

19. The non-transitory computer-readable medium of claim 14, wherein the one or more result reports further comprise data indicating a discrepancy between magnitudes of fulfillment of the campaign objective for the first content campaign and the second content campaign.

20. The non-transitory computer-readable medium of claim 14, wherein the one or more result reports further comprise data indicating a discrepancy between a combination of cost of fulfillment of the campaign objective and magnitude of fulfillment of the campaign objective for the first content campaign and the second content campaign.
